(19) United States
(12) Patent Application Publication
(10) Pub. No.: US 2024/0028373 A1
(43) Pub. Date: Jan. 25, 2024

(54) DECOUPLING OWNERSHIP RESPONSIBILITIES AMONG USERS IN A TELECOMMUNICATIONS CLOUD

(71) Applicant: VMWARE, INC., Palo Alto, CA (US)

(72) Inventors: ASHVIN LAKSHMIKANTA, Bangalore (IN); Umar Shaikh, Bangalore (IN); Kiran Kumar Cherivirala, Bangalore (IN); Venu Gopala Rao Kotha, Bangalore (IN); Sureshbabu Koyadan Chathoth, Bangalore (IN)

(21) Appl. No.: 17/975,702

(22) Filed: Oct. 28, 2022

(30) Foreign Application Priority Data
Jul. 22, 2022 (IN) 202241042075

(51) Int. Cl. G06F 9/455

(52) U.S. Cl. CPC G06F 9/45558; G06F 9/45545; G06F 2009/4557; G06F 2009/45595; G06F 9/541

(57) ABSTRACT

An example method of deploying an application by a telecommunications platform in a multi-cloud computing system includes: receiving, at the telecommunications platform executing in a first software-defined data center (SDDC), an application deployment specification for a first application; receiving, at the telecommunications platform, selection of a virtual infrastructure (VI) template for the first application, the VI template defining a configuration of SDDC resources in the multi-cloud computing system; and deploying the first application based on the application deployment specification of the first application and the VI template.

### RELATED APPLICATIONS

Benefit is claimed under 35 U.S.C. 119(a)-(d) to Foreign Application Serial No. 202241042075 filed in India entitled “DECOUPLING OWNERSHIP RESPONSIBILITIES AMONG USERS IN A TELECOMMUNICATIONS CLOUD”, on Jul. 22, 2022, by VMware, Inc., which is herein incorporated in its entirety by reference for all purposes.

### BACKGROUND

In a software-defined data center (SDDC), virtual infrastructure, which includes virtual compute, storage, and networking resources, is provisioned from hardware infrastructure that includes a plurality of host computers, storage devices, and networking devices. The provisioning of the virtual infrastructure is carried out by management software that communicates with virtualization software (e.g., hypervisor) installed in the host computers. SDDC users move through various business cycles, requiring them to expand and contract SDDC resources to meet business needs. This leads users to employ multi-cloud solutions, such as typical hybrid cloud solutions where the SDDC spans across an on-premises data center and a public cloud.

A telecommunications platform can be deployed in a multi-cloud system to support telecommunications applications, such as 4G/5G applications. The telecommunications platform can provide for bring up of various management appliances (e.g., virtualized infrastructure management appliances, network management appliances, etc.), as well as deployment of virtual network functions (VNFs) and container network functions (CNF) whose configuration is provided as part of an application deployment template. CNFs/VNFs are typically unique in their requirements of the underlying infrastructure. Applications are optimized for different metrics such as throughput, latency, etc. Consequently, the expectation of the underlying infrastructure for CNFs/VNFs and applications can be different. Managing then underlying infrastructure can be critical so that the CNFs/VNFs and applications provide the best performance to the end user.

### SUMMARY

In embodiments, a method of deploying an application by a telecommunications platform in a multi-cloud computing system includes: receiving, at the telecommunications platform executing in a first software-defined data center (SDDC), an application deployment specification for a first application; receiving, at the telecommunications platform, selection of a virtual infrastructure (VI) template for the first application, the VI template defining a configuration of SDDC resources in the multi-cloud computing system; and deploying the first application based on the application deployment specification of the first application and the VI template.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram depicting a multi-cloud computing system according to embodiments.

FIG. 2 is a block diagram of an SDDC in which embodiments described herein may be implemented.

FIG. 3 is a flow diagram depicting a method of deploying an application according to embodiments.

### DETAILED DESCRIPTION

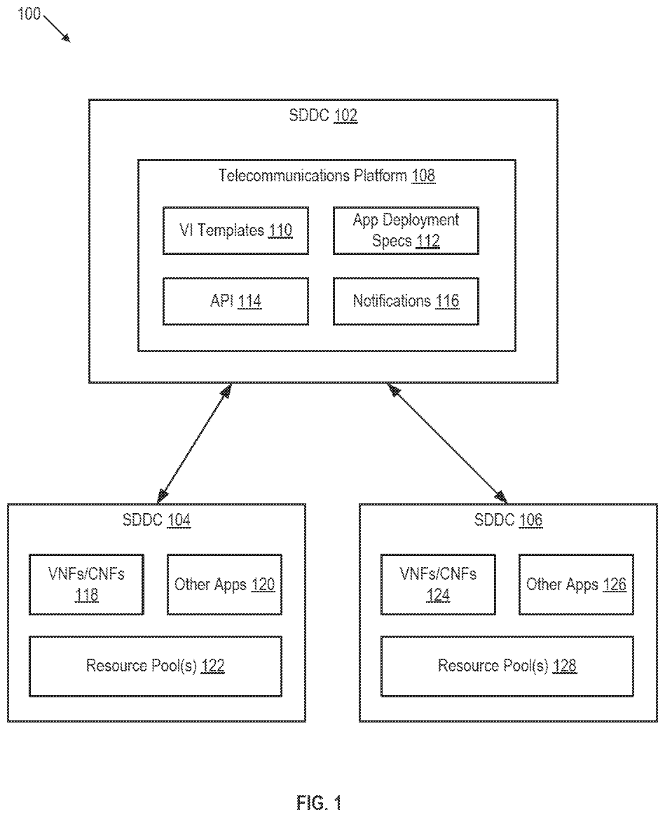

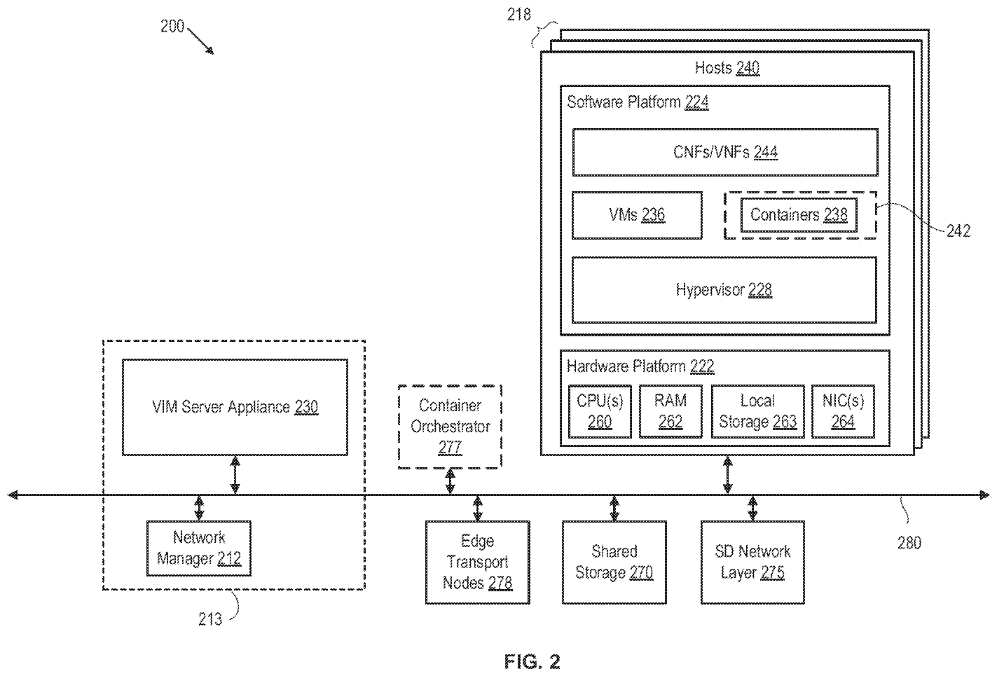

FIG. 1 is a block diagram depicting a multi-cloud computing system 100 according to embodiments. Multi-cloud computing system 100 includes a plurality of software-defined data centers (SDDCs), e.g., SDDCs 102, 104, and 106. While only three SDDCs are shown, it is to be understood that multi-cloud computing system 100 can include any number of SDDCs. SDDCs 102 can be implemented in public cloud(s), private cloud(s), or a combination thereof (e.g., hybrid cloud(s)). Embodiments of an SDDC are described below with respect to FIG. 2.

In the embodiment, SDDC 102 includes a telecommunications platform 108. Users interact with telecommunications platform 108 to deploy virtual network functions (VNFs), container network functions (CNFs), or other applications across SDDCs. VNFs are network functions deployed in a virtual machine (VM). CNFs are network functions deployed in containers. Network functions can include, for example, functions for processing network traffic in a 4G/5G mobile telecommunications system. In the example, a user deploys VNFs/CNFs 118 and other apps 120 within resource pool(s) 122 of SDDC 104. A user deploys VNFs/CNFs 124 and other apps 126 in resource pool(s) 128 of SDDC 106. Resource pools include collections of resources such as compute, memory, storage, networking, software, and the like.

FIG. 2 is a block diagram of an SDDC 200 in which embodiments described herein may be implemented. SDDC 200 includes a cluster of hosts 240 (“host cluster 218”) that may be constructed on server-grade hardware platforms such as an x86 architecture platforms. For purposes of clarity, only one host cluster 218 is shown. However, SDDC 200 can include many of such host clusters 218. As shown, a hardware platform 222 of each host 240 includes conventional components of a computing device, such as one or more central processing units (CPUs) 260, system memory (e.g., random access memory (RAM) 262), one or more network interface controllers (NICs) 264, and optionally local storage 263. CPUs 260 are configured to execute instructions, for example, executable instructions that perform one or more operations described herein, which may be stored in RAM 262. NICs 264 enable host 240 to communicate with other devices through a physical network 280. Physical network 280 enables communication between hosts 240 and between other components and hosts 240 (other components discussed further herein).

In the embodiment illustrated in FIG. 2, hosts 240 access shared storage 270 by using NICs 264 to connect to network 280. In another embodiment, each host 240 contains a host bus adapter (HBA) through which input/output operations (IOs) are sent to shared storage 270 over a separate network (e.g., a fibre channel (FC) network). Shared storage 270 include one or more storage arrays, such as a storage area network (SAN), network attached storage (NAS), car the like. Shared storage 270 may comprise magnetic disks, solid-state disks, flash memory, and the like as well as combinations thereof. In some embodiments, hosts 240 include local storage 263 (e.g., hard disk drives, solid-state drives, etc.). Local storage 263 in each host 240 can be aggregated and provisioned as part of a virtual SAN (vSAN), which is another form of shared storage 270.

A software platform 224 of each host 240 provides a virtualization layer, referred to herein as a hypervisor 228, which directly executes on hardware platform 222. In an embodiment, there is no intervening software, such as a host operating system (OS), between hypervisor 228 and hardware platform 222. Thus, hypervisor 228 is a Type-1 hypervisor (also known as a “bare-metal” hypervisor). As a result, the virtualization layer in host cluster 218 (collectively hypervisors 228) is a bare-metal virtualization layer executing directly on host hardware platforms, Hypervisor 228 abstracts processor, memory, storage, and network resources of hardware platform 222 to provide a virtual machine execution space within which multiple virtual machines (VM) 236 may be concurrently instantiated and executed. CNFs/VNFs 244 or other applications execute in VMs 236 and/or containers 238 (discussed below).

Host cluster 218 is configured with a software-defined (SD) network layer 275. SD network layer 275 includes logical network services executing on virtualized infrastructure in host cluster 218. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, SDDC 200 includes edge transport nodes 278 that provide an interface of host cluster 218 to a wide area network (WAN) (e.g., a corporate network, the public Internet, etc.).

VIM server appliance 230 is a physical or virtual server that manages host cluster 218 and the virtualization layer therein. VM server appliance 230 installs agent(s) in hypervisor 228 to add a host 240 as a managed entity. VM server appliance 230 logically groups hosts 240 into host cluster 218 to provide cluster-level functions to hosts 240, such as VM migration between hosts 240 (e.g., for load balancing), distributed power management, dynamic VM placement according to affinity and anti-affinity rules, and high-availability. The number of hosts 240 in host cluster 218 may be one or many. VM server appliance 230 can manage more than one host cluster 218.

In an embodiment, SDDC 200 further includes a network manager 212. Network manager 212 is a physical or virtual server that orchestrates SD network layer 275. In an embodiment, network manager 212 comprises one or more virtual servers deployed as VMs. Network manager 212 installs additional agents in hypervisor 228 to add a host 240 as a managed entity, referred to as a transport node. In this manner, host cluster 218 can be a cluster of transport nodes. One example of an SD networking platform that can be configured and used in embodiments described herein as network manager 212 and SD network layer 275 is a VMware NSX® platform made commercially available by VMware, Inc. of Palo Alto, CA.

VIM server appliance 230 and network manager 212 comprise a virtual infrastructure (VI) control plane 213 of SDDC 200. VIM server appliance 230 can include various VI services. The VI services include various virtualization management services, such as a distributed resource scheduler (DRS), high-availability (HA) service, single sign-on (SSO) service, virtualization management daemon, and the like. An SSO service, for example, can include a security token service, administration server, directory service, identity management service, and the like configured to implement an SSO platform for authenticating users.

In embodiments. SDDC 200 can include a container orchestrator 277. Container orchestrator 277 implements an orchestration control plane, such as Kubernetes®, to deploy and manage applications or services thereof on host cluster 218 using containers 238. In embodiments, hypervisor 228 can support containers 238 executing directly thereon. In other embodiments, containers 238 are deployed in VMs 236 or in specialized VMs referred to as “pod VMs 242.” A pod VM 242 is a VM that includes a kernel and container engine that supports execution of containers, as well as an agent (referred to as a pod VM agent) that cooperates with a controller executing in hypervisor 228 (referred to as a pod VM controller). Container orchestrator 277 can include one or more master servers configured to command and configure pod VM controllers in host cluster 218. Master server(s) can be physical computers attached to network 280 or VMs 236 in host cluster 218.

Returning to FIG. 1, requirements for VNFs/CNFs can be broken down into different configurations of the underlying virtual infrastructure, e.g., non-uniform memory access (NUMA) configuration, operating system kernel version, SR-IOV configuration, and the like. In some systems, applications provide their VI requirements as part of the application deployment specification. In embodiments, application deployment specifications comply with a certain standard or standards associated with the telecommunication application. While such standard(s) define specifications for the application, the standard(s) do not specify requirements for the underlying virtual infrastructure. Thus, some systems support extensions to the application deployment specification that define requirements for the underlying VI. For example, extensions can identify a resource pool in which the application can be deployed and in some cases modify the underlying VI of the identified resource pool to suit the application's requirements. These systems allow deployment of a generic virtual infrastructure that can be customized as the applications are deployed.

However, there are a number of problematic issues with such a system. One problem is the non-standard application deployment specifications. Application deployment specifications that modify the underlying virtual infrastructure are not part of the standard(s) and are typically specific to the underlying VI. Consequently, any VNF/CNF provider must adhere to the specific VI being used when developing the application specification. This is not a scalable solution. In addition, some vendors may allow for non-standard application deployment specifications in their systems (e.g., those that are non-compliant with the relevant standard(s)).

Moreover, in platform as a service (PAAS) or container as a server (CAAS) models, there is an expectation of separation of responsibilities between the infrastructure team and the application teams. However, in the system design discussed above, the applications are allowed to make arbitrary changes to the underlying virtual infrastructure through extensions in their specifications. This leads to sharing of responsibilities for the security and stability of the platform between application and infrastructure teams. Such a coupling is undesirable for many operators.

In addition, such a solution allows allocations to be deployed on arbitrary resource pools. If multiple applications are deployed on the same resource pool, they could present conflicting requirements to the infrastructure. In such a scenario, the solution leads to unpredictable behavior (e.g., one CNF has a requirement of Linux® kernel 4.9 while another CNF has a requirement of kernel 5.2 being deployed in the same resource pool).

In embodiments, telecommunications platform 108 decouples ownership responsibilities between VI and application teams. Users in the application teams submit application deployment specifications 112 that define application requirements, but not underlying VI requirements. Thus, application deployment specifications 112 can be fully compliant with the relevant telecommunications standards. Telecommunications platform 108 provides VI templates 110 for selection by the users of the application team. A user can submit an application deployment specification 112 and then select a VI template 110 for the application. VI template 110 defines a resource pool 122/128 into which the application will be deployed. Different VI templates 110 (and hence underlying resource pools) can be provided that support various applications. If an application has VI requirements not supported by the current set of VI templates 110, the user can request a new VI configuration to support the application (e.g., a new set of compute, memory, storage, networking, software, etc.). Telecommunications platform 108 generates notifications 116 in response to these requests from application team users. Users on the VI team (e.g., VI admins) can process notifications 116 and determine if current VI policies support creation of new VI configurations as requested. For those that do not comply, the VI admin can deny the request and telecommunications platform 108 notifies the user that submitted the request. For those that do comply, the VI admin creates a new VI template 110 defining the new configuration, as well as the corresponding resource pool. The user submitting the request can then select the new VI template for deployment of the application.

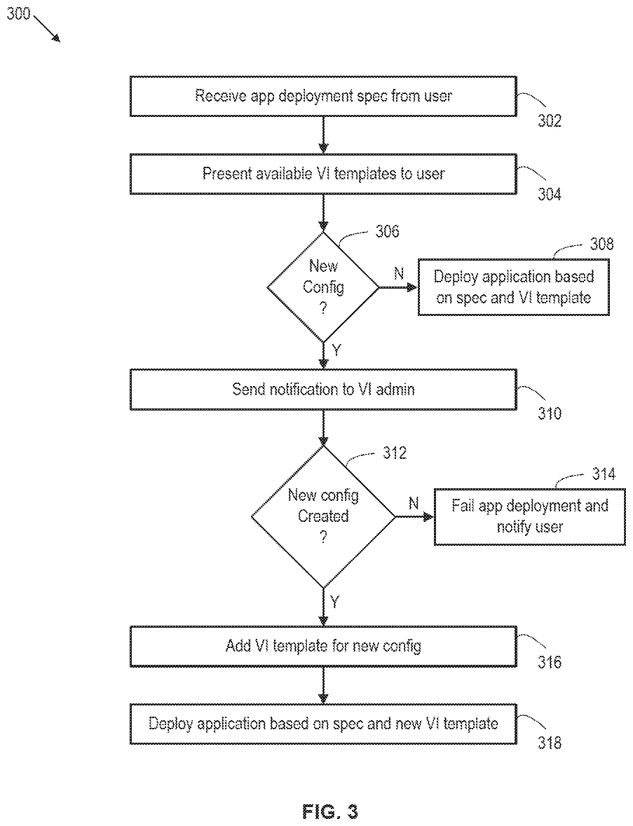

FIG. 3 is a flow diagram depicting a method 300 of deploying an application according to embodiments. Method 300 may be understood with respect to multi-cloud system 100 described in FIG. 1. Method 300 begins at step 302, where telecommunications platform 108 receives an application deployment specification 112 from a user (e.g., a user on an application team). Application deployment specification 112 describes the application (e.g., VNF, CNF, other application), but does not include any requirements of the underlying virtual infrastructure. Application deployment specification 112 can be fully compliant with one or more relevant telecommunications standards. At step 304, telecommunications platform 108 presents VI templates 110 to the user for selection. VI templates 110 define different resource pools and the configurations thereof into which the application can be deployed. The user can select a VI template 110 that supports the requirements of the application.

At step 306, telecommunications system 108 determines if a new configuration is requested. For example, the user may request a new VI configuration for the application upon reviewing the available VI templates (e.g., there are no suitable VI templates for the application being deployed). If a new configuration is not requested, method 300 proceeds to step 308, where the telecommunications platform 108 deploys the application based on its application deployment specification and the selected VI template (e.g., deployed into the resource pool corresponding to the VI template). If a new configuration has been requested, method 300 proceeds to step 310.

At step 310, telecommunications platform 108 generates a notification of the requested VI configuration. In embodiments, the generated notification can be received and reviewed by a user of the infrastructure team (e.g., a VI admin). The VI admin can determine if the new VI configuration is consistent with current policies. If permitted, the VI admin can create the resource pool consisted with the requested new configuration and generate a new VI template describing the same. If not permitted or desired, the VI admin can reject the request. At step 312, telecommunications platform 108 determines if a new configuration has been created. If not, method 300 proceeds to step 314, where telecommunication platform 108 fails the application deployment and notifies the requesting user. If the new configuration has been created, method 300 proceeds to step 316, where telecommunications platform 108 adds a new VI template for the new configuration. The VI admin can create the resource pool and add the new configuration using API 114 of telecommunication platform 108. At step 318, the user of the application team deploys the application based on its application deployment specification and the new VI template.

In embodiments, telecommunications platform 108 described herein decouples infrastructure from applications. Modifications to infrastructure are only performed by infrastructure admins. As such, the security and stability of the infrastructure cannot be compromised by an ill-defined application deployment specification. Since infrastructure modifications cannot be performed by applications, the underlying infrastructure cannot proceed to an indeterminate state due to conflicting requirements presented by applications. Further, as infrastructure requirements are moved out of application deployment specifications, any standard compliant CNF/VNF can be deployed using their specifications. No modification is necessary for these CNFs/VNFs to be deployable on the infrastructure (e.g., no non-compliant extensions to the application deployment specification are necessary).

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of deploying an application by a telecommunications platform in a multi-cloud computing system, the method comprising:
receiving, at the telecommunications platform executing in a first software-defined data center (SDDC), an application deployment specification for a first application;
receiving, at the telecommunications platform, selection of a virtual infrastructure (VI) template for the first application, the VI template defining a configuration of SDDC resources in the multi-cloud computing system; and
deploying the first application based on the application deployment specification of the first application and the VI template.

2. The method of claim 1, wherein the application deployment specification is exclusive of requirements on the SDDC resources in the multi-cloud computing system.

3. The method of claim 1, wherein the configuration of the SDDC resources comprises a resource pool in the multi-cloud computing system.

4. The method of claim 1, further comprising:
receiving, at the telecommunications platform, an application deployment specification for a second application;
receiving, at the telecommunications platform, a request for a new configuration of the SDDC resources in the multi-cloud computing system; and
generating, by the telecommunications platform, a notification of the new configuration as requested.

5. The method of claim 4, further comprising:
receiving, at the telecommunications platform, a denial of the new configuration in response to the notification; and
generating a notification of application deployment failure in response to the denial.

6. The method of claim 4, further comprising:
receiving, through an application programming interface (API) of the telecommunications platform, instructions to deploy a new configuration of the SDDC resources; and
generating, by the telecommunications platform, a new VI template for the new configuration of the SDDC resources.

7. The method of claim 6, further comprising:
receiving, at the telecommunications platform, selection of the new VI template for the second application; and
deploying the second application based on the application deployment specification of the second application and the new VI template.

8. A non-transitory computer readable medium comprising instructions to be executed in a computing device to cause the computing device to carry out a method of deploying an application by a telecommunications platform in a multi-cloud computing system, the method comprising:
receiving, at the telecommunications platform executing in a first software-defined data center (SDDC), an application deployment specification for a first application;
receiving, at the telecommunications platform, selection of a virtual infrastructure (VI) template for the first application, the VI template defining a configuration of SDDC resources in the multi-cloud computing system; and
deploying the first application based on the application deployment specification of the first application and the VI template.

9. The non-transitory computer readable medium of claim 8, wherein the application deployment specification is exclusive of requirements on the SDDC resources in the multi-cloud computing system.

10. The non-transitory computer readable medium of claim 8, wherein the configuration of the SDDC resources comprises a resource pool in the multi-cloud computing system.

11. The non-transitory computer readable medium of claim 8, further comprising:
receiving, at the telecommunications platform, an application deployment specification for a second application;
receiving, at the telecommunications platform, a request for a new configuration of the SDDC resources in the multi-cloud computing system; and
generating, by the telecommunications platform, a notification of the new configuration as requested.

12. The non-transitory computer readable medium of claim 11, further comprising:
receiving, at the telecommunications platform, a denial of the new configuration in response to the notification; and
generating a notification of application deployment failure in response to the denial.

13. The non-transitory computer readable medium of claim 12, further comprising:
receiving, through an application programming interface (API) of the telecommunications platform, instructions to deploy a new configuration of the SDDC resources; and
generating, by the telecommunications platform, a new VI template for the new configuration of the SDDC resources.

14. The non-transitory computer readable medium of claim 13, further comprising:
receiving, at the telecommunications platform, selection of the new VI template for the second application; and
deploying the second application based on the application deployment specification of the second application and the new VI template.

15. A multi-cloud computing system, comprising:
a first software-defined data center (SDDC) executing a telecommunications platform;
SDDC resources in the first SDDC, at least one additional SDDC, or both the first SDDC and the at least additional SDDC;
wherein the telecommunications platform is configured to:
receive an application deployment specification for a first application;
receive selection of a virtual infrastructure (VI) template for the first application, the VI template defining a configuration of the SDDC resources; and
deploy the first application based on the application deployment specification of the first application and the VI template.

16. The multi-cloud computing system of claim 15, wherein the application deployment specification is exclusive of requirements on the SDDC resources in the multi-cloud computing system.

17. The multi-cloud computing system of claim 15, wherein the telecommunications platform is configured to:
receive an application deployment specification for a second application;
receive a request for a new configuration of the SDDC resources in the multi-cloud computing system; and
generate a notification of the new configuration as requested.

18. The multi-cloud computing system of claim 17, wherein the telecommunications platform is configured to:
receive a denial of the new configuration in response to the notification; and
generate a notification of application deployment failure in response to the denial.

19. The multi-cloud computing system of claim 18, wherein the telecommunications platform is configured to:
receive, through an application programming interface (API), instructions to deploy a new configuration of the SDDC resources; and
generate a new VI template for the new configuration of the SDDC resources.

20. The multi-cloud computing system of claim 19, wherein the telecommunications platform is configured to:
receive selection of the new VI template for the second application; and
deploy the second application based on the application deployment specification of the second application and the new VI template.
